(19) United States
(12) Patent Application Publication
(10) Pub. No.: US 2023/0228241 A1
(43) Pub. Date: Jul. 20, 2023

(54) RENEWABLE ENERGY GENERATOR

(71) Applicants: Hyundai Motor Company, Seoul (KR); Kia Corporation, Seoul (KR)

(72) Inventors: Dong Hyun HA, Seoul (KR); Jung Hun CHOI, Hwaseong-Si (KR); Jae Wung JUNG, Bucheon-Si (KR)

(73) Assignees: Hyundai Motor Company, Seoul (KR); Kia Corporation, Seoul (KR)

(21) Appl. No.: 17/852,110

(22) Filed: Jun. 28, 2022

(30) Foreign Application Priority Data
Jan. 20, 2022 (KR) 10-2022-0008516

(51) Int. Cl. F03B 13/16; F03G 3/06

(52) U.S. Cl. CPC F03B 13/16; F03G 3/06; F05B 2220/706; F05B 2260/42

(57) ABSTRACT

A renewable energy generator includes a housing having the shape of a roly-poly-like capsule that floats in a sea; a main generation unit including an internal housing, a pendulum provided to be movable within the internal housing, a pendulum rotation shaft connected to the pendulum and rotatably connected to the internal housing, a main motor configured to convert the pendulum’s kinetic energy into electrical energy, and a gear set coupling the main motor and the pendulum rotation shaft and configured to transfer the kinetic energy of the pendulum to the main motor; frames fixed to the inside of the housing at predetermined intervals; a main rotation shaft rotatably connecting the main generation unit to at least one of the frames for the main generation unit to rotate with respect to the at least one of the one or more frames; and a controller configured to control the main generation unit.

### CROSS-REFERENCE TO RELATED APPLICATIONS

The present application claims priority to Korean Patent Application No. 10-2022-0008516, filed Jan. 20, 2022, the entire contents of which is incorporated herein for all purposes by this reference.

### BACKGROUND OF THE PRESENT DISCLOSURE

### Field of the Present Disclosure

The present disclosure relates to a renewable energy generator.

### Description of Related Art

The description in this section merely provides background information related to the present disclosure and does not necessarily form the related art.

Thermal power generation using chemical energy from fossil fuels to produce electric power, hydropower generation using the potential energy of water stored in dams, nuclear power generation using nuclear fission of uranium are among the most widely used technologies for producing electric power.

However, in recent years, resource depletion, safety issues, and eco-friendly values are increasingly propelling renewable energy productions in proportion over the three major power generation sources. Renewable energy includes power generation using infinite energy sources such as solar power, solar heat, tidal power, wave power, wind power, and geothermal heat.

More than 70% of the earth’s surface is the sea that borders different countries with large bodies of water making them good environmental candidates to take advantage of the infinite energy of the waters, which garners increasing interest in wave power generation. Wave power generation refers to the production of electrical energy by use of the periodic vertical motion of the water surface caused by waves.

Large-scale wave power generation has spatial limitations to onshore installation. Also, installing a wave power generation device in distant seas and coastal and offshore waters faces difficulties in energy transfer and requires installing costly subsea cables, incurring considerable expenses.

Built-in, stationary wave power generation devices have difficulty producing stable electric power because of their irregular horizontal and vertical movements caused by irregular motions of waves. That is, it is hard to generate stable electric power by coping with sea surface changes, making it impossible to efficiently produce electric power.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a renewable energy generator including: a housing having the shape of a roly-poly-like capsule that floats in a sea; a main generation unit including an internal housing, a pendulum configured to be movable within the internal housing, a pendulum rotation shaft connected to the pendulum and rotatably connected to the internal housing, a main motor configured to convert the pendulum’s kinetic energy into electrical energy, and a gear set coupling the main motor and the pendulum rotation shaft and configured to transfer the kinetic energy of the pendulum to the main motor; one or more frames fixed to the inside of the housing at predetermined intervals; a main rotation shaft rotatably connecting the main generation unit to at least one of the one or more frames for the main generation unit to rotate with respect to the at least one of the one or more frames; and a controller configured to control the main generation unit.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram of a renewable energy generation system using a renewable energy generator according to an exemplary embodiment of the present disclosure.

FIG. 2 is a view showing an external surface of a housing of a renewable energy generator according to an exemplary embodiment of the present disclosure.

FIG. 3 is a cross-sectional view of a cutting plane perpendicular to the x axis of a renewable energy generator according to an exemplary embodiment of the present disclosure.

FIG. 4 is a schematic cross-sectional view of a cutting plane perpendicular to the y axis of a renewable energy generator according to an exemplary embodiment of the present disclosure.

FIG. 5 is a schematic view of the inside of a main generation unit of a renewable energy generator according to an exemplary embodiment of the present disclosure.

FIG. 6 is a schematic view showing the position of a communication module of a renewable energy generator according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

A renewable energy generator according to various exemplary embodiments of the present disclosure may produce energy in coastal and offshore waters and distant seas by converting wave energy into electrical energy.

A renewable energy generator according to various exemplary embodiments of the present disclosure may produce electric power effectively by controlling motors by considering the intensity, speed, and cycle of waves.

The aspects of the present disclosure are not limited to the foregoing, and other aspects not mentioned herein will be able to be clearly understood to those skilled in the art from the following description.

Hereinafter, various exemplary embodiments of the present disclosure will be described in detail with reference to the accompanying drawings. In the following description, like reference numerals designate like elements, although the elements are shown in different drawings. Furthermore, in the following description of various exemplary embodiments of the present disclosure, a detailed description of related known components and functions when considered to obscure the subject of the present disclosure will be omitted for clarity and for brevity.

Additionally, alphanumeric codes such as first, second, i), ii), (a), (b), etc., in numbering components are used solely for differentiating one component from the other but not to imply or suggest the substances, the order, or sequence of the components. Throughout the present specification, when parts “include” or “comprise” a component, they are meant to further include other components, not excluding thereof unless there is a particular description contrary thereto.

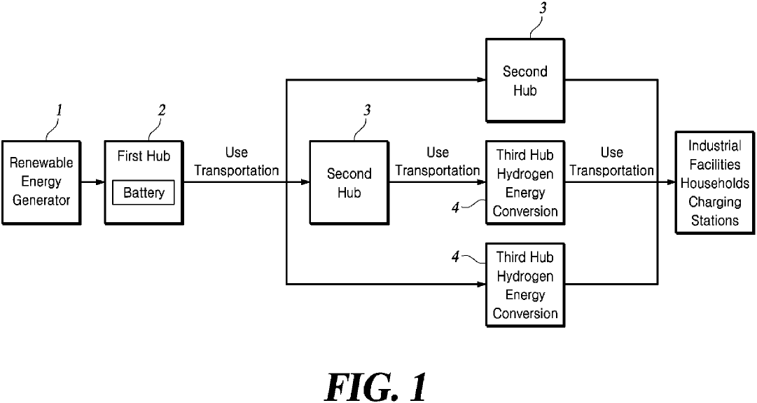

FIG. 1 is a block diagram of a renewable energy generation system using a renewable energy generator 1 according to at least an exemplary embodiment of the present disclosure.

As shown in FIG. 1, the renewable energy generation system may include the renewable energy generator 1, a first hub 2, second hubs 3, third hubs 4, transportation, and a battery in whole or in part.

Multiples of renewable energy generator 1 may be interconnected by use of a cable 113, and they may float in the coastal waters and distant seas. The plurality of renewable energy generators 1 may each be shaped as a roly-poly toy or capsule. The plurality of renewable energy generators 1 may each convert wave energy into electrical energy to produce electric power.

The renewable energy generator 1 may have a surface thereof provided with solar panels 111. The solar panels 111 may be provided on the top portion of the surface of the renewable energy generator 1, for example, the part which is not submerged in seawater. The renewable energy generator 1 can not only convert wave energy into electrical energy but also convert solar energy into electrical energy by use of solar panels 111.

The first hub 2 may be positioned to be surrounded by a plurality of renewable energy generators 1. The first hub 2 may be cabled to the plurality of renewable energy generators 1 and may receive electrical energy therefrom. The first hub 2 may receive and store electrical energy from the renewable energy generators 1. The electrical energy transferred to the first hub 2 may charge a battery and transportation coupled to the first hub 2. In the instant case, the transportation may be an unmanned aerial vehicle (UAV), an unmanned ship, a drone, or the like.

The second hubs 3 may each be positioned to be surrounded by a plurality of first clusters including the first hub 2. The third hubs 4 may each be positioned to be surrounded by a plurality of second clusters including the second hub 3.

The transportation may deliver battery and electrical energy between the first hub 2, the second hubs 3, and the third hubs 4 to each other. Additionally, the transportation may deliver the battery and electrical energy to the first hub 2, the second hubs 3, the third hubs 4, and a separate place located on the ground. Here, the separate place may be present and future mobility means such as an electric vehicle (EV), purpose-built vehicle (PBV), urban air mobility (UAM), robot, their electric charging stations, households, industrial facilities, etc. For example, with Vehicle To Grid (V2G) technology, a rechargeable eco-friendly vehicle may be linked to a power grid to use surplus power as provided by the present disclosure. The eco-friendly vehicle may work as a moving energy storage system (ESS) by use of the power grid to first charge the vehicle and feed the remaining electricity back to the power grid after the vehicle operation.

The renewable energy generation system can convert electrical energy into hydrogen energy and transfer the converted hydrogen energy. When energy is stored in the first hub 2 to the third hubs 3 for a long time, a large amount of energy (1 TWh or more) may be stored. For large-capacity energy storage, hydrogen energy is a more suitable form of energy than electrical energy. Additionally, because hydrogen energy loses less than electrical energy during long-distance transport, hydrogen energy is suitable for international transport of energy.

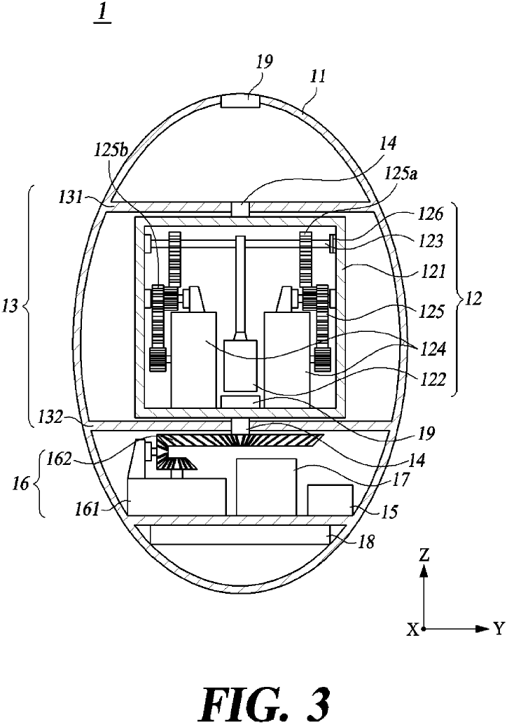

FIG. 2 is a view showing an external surface of a housing of a renewable energy generator according to an exemplary embodiment of the present disclosure.

Referring to FIG. 2, the renewable energy generator 1 of the present disclosure may include all or part of a solar panel 111, external walls 112, and a cable 113.

The external walls 112 may be protruded from the external surface of the housing 11. The external walls 112 may be protruded in the shape of a honeycomb structure, and grooves may be formed between the external walls 112 so that they are cut inwardly of the external walls 112. The solar panel 111 may be mounted in the grooves formed between the external walls 112. As the solar panel 111 is mounted in the grooves formed between the external walls 112, damage to the solar panel 111 may be prevented even in the event of a collision with other renewable energy power generators 1 or other objects. The solar panel 111 and the external walls 112 may be provided in an upper portion of the surface of the housing 11, that is, a portion which is not submerged in seas.

Moreover, the housing 11 of the renewable energy generator 1 of the present disclosure may be made of a highly durable material to withstand high and strong waves and typhoons. The external walls 112 also may be made of a highly durable material to withstand high and strong waves and typhoons and designed to provide a highly durable structure.

The cable 113 may transfer electrical energy stored in a battery 18 to other renewable energy generators 1, the first hub 2, or a predetermined place. The cable 113 is a flexible cable, and a cable with high energy transfer efficiency may be used as the cable 113. For example, the cable 113 of the renewable energy generator 1 of the present disclosure may have a transfer efficiency of 99.7 % or higher when transferring electrical energy over a distance of 100 km.

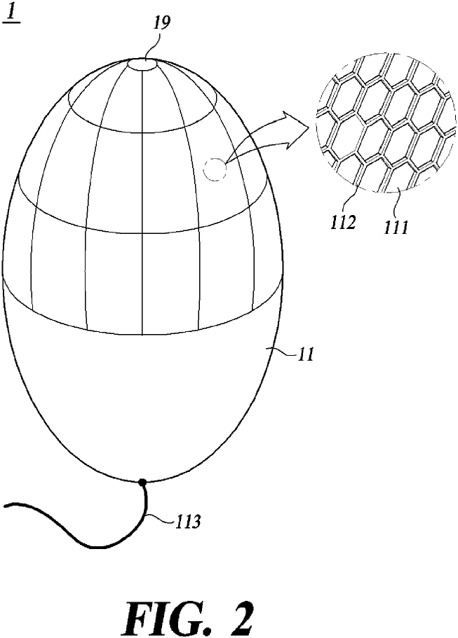

FIG. 3 is a cross-sectional view of a cutting plane perpendicular to the x axis of a renewable energy generator according to an exemplary embodiment of the present disclosure.

In the exemplary embodiment, the z axis refers to a direction perpendicular to the sea surface, the x axis refers to a direction perpendicular to the z axis and parallel to the motion of a pendulum 122, and the y axis refers to a direction perpendicular to the x axis and the z axis.

Referring to FIG. 3, the renewable energy generator 1 may include all or part of the housing 11, a main generation unit 12, a frame 13, a main rotation shaft 14, a controller 15, an auxiliary generation unit 16, a solar generator 17, a battery 18, and a communication module 19.

The housing 11 may be in the shape of a roly-poly toy or capsule to be able to float in the coastal waters and distant seas. A solar panel 111 may be provided on the surface of the housing 11. The housing 11 may have its upper end portion provided with a communication module 19. The communication module 19 may be an Ultra Wide Band-based (UWB-based) module for determining the absolute coordinates (x, y, z) of the renewable energy generator 1. For example, the communication module 19 may monitor the tilted state of the renewable energy generator 1 and determine the tilt angle to control the behavior of the renewable energy generator 1.

The frame 13 may include an upper frame 131 and a lower frame 132. The upper frame 131 and the lower frame 132 may be fixed to the inside of the housing 11, with a predetermined distance between them along the z axis within the housing 11. The main generation unit 12 may be connected between the upper frame 131 and the lower frame 132. The main rotation shaft 14 may be connected to the upper frame 131 and the lower frame 132, and the main rotation shaft 14 may be connected in such a way as to make the main generation unit 12 rotatable.

The main generation unit 12 may include all or part of an internal housing 121, the pendulum 122, a pendulum rotation shaft 123, a main motor 124, a gear set 125, and a rotating angle sensor 126.

The main generator unit 12 may generate electric power by converting wave energy into electrical energy by use of the movement of the pendulum 122. The pendulum 122 inside the main generator unit 12 moves in accordance with the movement of the waves, and the kinetic energy of the pendulum 122 is converted into electrical energy. The motion of the pendulum 122 may be transmitted to the main motors 124 via the pendulum rotation shaft 123 and the gear sets 125. The main motors 124 may generate and store electrical energy in the battery 18. The main motors 124 may operate in an electricity generation mode for generating electrical energy.

The gear set 125 may include a first gear unit 125a and a second gear unit 125b. The gear set 125 may increase the power generation efficiency of the renewable energy generator 1 by amplifying the motion of the pendulum by a gear ratio. For example, if the first gear unit 125a has a gear ratio of 10:1 and the second gear unit 125b has a gear ratio of 10:1, the gear set 125 has a total gear ratio of 100:1. If the gear set 125 has a gear ratio of 100:1, when the pendulum 122 moves, the number of rotations of the main motor 124 may be amplified by 10 times the motion of the pendulum 122. That is, a large amount of electrical energy may be produced relative to the motion of the pendulum 122.

The auxiliary generation unit 16 may include an auxiliary motor 161 and an auxiliary gear unit 162. The auxiliary gear unit 162 may be connected to the main rotation shaft 14, and the auxiliary motor 161 may be connected to the auxiliary gear unit 162. The auxiliary generation unit 16 may be provided outside the main generation unit 12. It may be provided at the bottom portion of the lower frame 132.

The movement of the pendulum 122 in accordance with the changes in the waves may cause a moment of rotational inertia in the main generator unit 12. When the main generator unit 12 rotates due to the moment of rotational inertia, the rotation of the main generator unit 12 may be transmitted to the auxiliary motor 161 via the main rotation shaft 14 and the auxiliary gear unit 162. The auxiliary motor 16 may additionally produce electrical energy and store the electrical energy profit in the battery 18. By use of the main generation unit 12 and the auxiliary generation unit 16, the renewable energy generator 1 may convert various kinds of wave energy, such as rolling, pitching, yawing, potential energy, and kinetic energy from up/down and left/right movements. At the instant time, the auxiliary motor 161 may operate in an electricity generation mode for producing electrical energy.

Because the movement of the pendulum 122 is made in only one direction, the irregular movement of the waves makes it difficult to steadily produce electric power. In other words, there is a problem in that it is difficult to produce electricity efficiently because steady generation of electricity is difficult in response to the fluctuation of the sea level.

The controller 15 of the renewable energy generator 1 according to at least an exemplary embodiment of the present disclosure may take into account parameters such as the intensity, speed, and frequency of the waves to control the renewable energy generator 1. For example, the controller 15 may increase the electricity generation efficiency of the renewable energy generator 1 by rotating the same by taking into account the intensity, speed, and frequency of the waves. The controller 15 may control the renewable energy generator 1 to use various forms of wave energy such as rolling, pitching, yawing, potential energy, and vertical and horizontal kinetic energy. The controller 15 may control the main motor 124 and the auxiliary motor 161 in a driving mode to drive the renewable energy generator 1, so that the renewable energy generator 1 may produce electrical energy efficiently.

The solar generator 17 may convert solar energy absorbed by the solar panel 111 into electrical energy. The battery 18 may temporarily store electrical energy produced by the main motor 124 and the auxiliary motor 161 and transfer it to a predetermined place by use of the cable 113. Also, the battery 18 may supply energy needed to control the main motor 124 and the auxiliary motor 161 in the driving mode, energy needed to operate a gyro sensor 127 and the communication module 19, and energy needed to operate the solar generator 17.

In an exemplary embodiment of the present invention, the gear set 125 includes a first gear set and a second gear set, the main motor 124 includes a first main motor and a second main motor, the first gear set is coupled to a first end portion of the pendulum rotation shaft 123 and the first main motor, and the second gear set is coupled to a second end portion of the pendulum rotation shaft 123 and the second main motor.

In an exemplary embodiment of the present invention, the first gear set and the first main motor are aligned symmetric with the second gear set and the second main motor with respect to the pendulum 122.

Referring to FIG. 3, the solar generator 17, the controller 15, and the battery 18 may be provided at an inside bottom portion of the housing 11 to lower the center of gravity of the renewable energy generator 1.

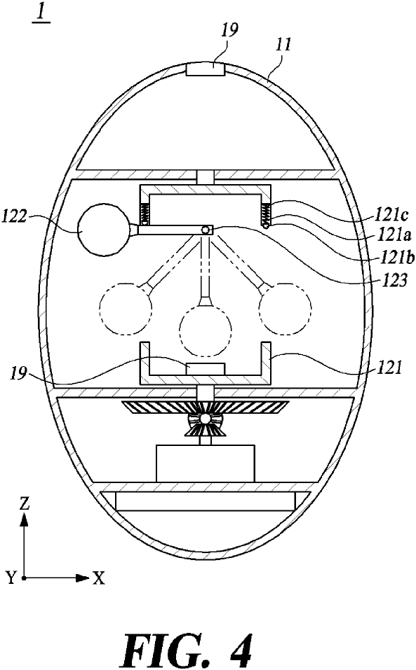

FIG. 4 is a schematic cross-sectional view of a cutting plane perpendicular to the y axis of a renewable energy generator according to an exemplary embodiment of the present disclosure.

Referring to FIG. 4, the internal housing 121 of the main generation unit 12 may further include a stumbling block 121a, a stopper 121b, and a spring 121c.

The stumbling block 121a may be formed on one side of the internal housing 121 and restrict the motion of the pendulum 122. The motion of the pendulum 122 may be restricted up to ±90 degrees with respect to the pendulum rotation shaft 123. By restricting the range of motion of the pendulum 122, the renewable energy generator 1 may produce electrical energy efficiently without wasting the kinetic energy of the pendulum 122.

The stopper 121b and the spring 121c may be provided at an end portion of the stumbling block 121a. The stopper 121b may be made of a rubber material to prevent damage caused when the pendulum 122 collides with the stumbling block 121a. The stopper 121b may be provided at an end portion of the stumbling block 121a, and the spring 121c may be provided inside the stumbling block 121a to be connected to the stopper 121b. Because the spring 121 is connected to the stopper 121b,it may cause the pendulum 122 to rebound when the pendulum 122 collides with the stopper 121b. The stopper 121b where the spring 121c is connected may increase the power generation efficiency of the renewable energy generator 1 as it assists the motion of the pendulum 122 by causing the pendulum 122 to rebound.

In an exemplary embodiment of the present invention, the stumbling block 121a includes a first stumbling block to restrict the motion of the pendulum 122 in a first rotation direction of the pendulum 122 and a second stumbling block to restrict the motion of the pendulum 122 in a second rotation direction of the pendulum 122.

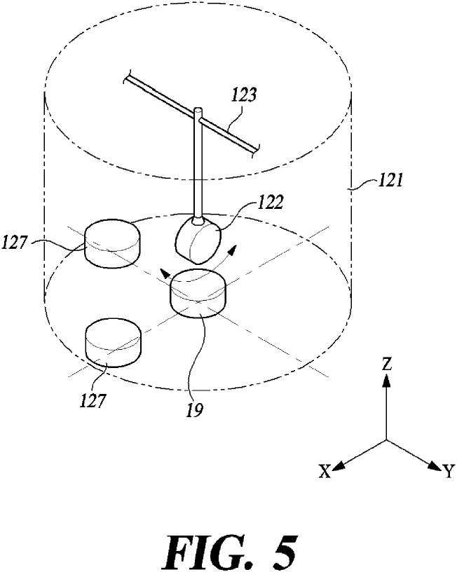

FIG. 5 is a schematic view of the inside of a main generation unit of a renewable energy generator according to an exemplary embodiment of the present disclosure.

Referring to FIG. 5, the main regeneration unit 12 may further include one or more gyro sensors 127 and a communication module 19.

The gyro sensor 127 refers to a sensor which is configured to measure changes in the orientation of an object using its property of constantly maintaining its original orientation regardless of the Earth’s rotation. The intensity of waves may be determined by use of the gyro sensor 127. That is, the intensity, number of oscillations, speed, and pattern of waves may be determined by use of the gyro sensor 127. Although FIG. 5 depicts the gyro sensor 127 being positioned inside the main generation unit 12, it may be positioned outside the main generation unit 12 or, if necessary, the number of gyro sensors 127 may be increased or decreased.

Position information of the renewable energy generator 1 may be determined by use of the communication module 19. The absolute coordinates of the renewable energy generator 1 may be determined by use of an ultra-wideband (UWB) communication module 19. That is, the movement of the renewable energy generator 1 may be controlled by monitoring the tilted position of the renewable energy generator 1 and determining the tilting angle thereof. Although FIG. 3 depicts the communication module 19 being positioned at the bottom center portion of the main generation unit 12, the position of the communication module 19 is not limited to this and may be positioned outside the main generation unit 12.

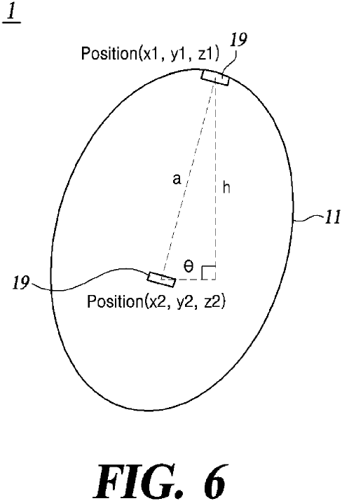

FIG. 6 is a schematic view showing the position of a communication module of a renewable energy generator according to an exemplary embodiment of the present disclosure.

Referring to FIG. 5 and FIG. 6, the communication module 19 may be positioned on the inside top of the renewable energy generator 1 and at the center portion of an inside bottom portion of the main generation unit 12. Using the communication module 19, the tilted position of the renewable energy generator 1 may be monitored, and the tilting angle thereof may be measured. The controller 15 may determine the tilting angle of the renewable energy generator 1 and control the movement of the renewable energy generator 1.

The communication module 19 may include a first communication module positioned on an internal top of the renewable energy generator 1 and a second communication module positioned at the center portion of an inside bottom portion of the main generation unit 12. The position of the first communication module may be (x1, y1, z1), and the position of the second communication module maybe (x2, y2, z2).

a is the distance between the first communication module and the second communication module. a is set in the manufacturing stage of the renewable energy generator 1, and as a constant, it is a value unrelated to the movement of the renewable energy generator 1. h may be determined to be h = z1 - z2 which is the difference between the z coordinate values of the first communication module and the second communication module. Θ is the tilting angle of the renewable energy generator 1, which may be obtained by use of a and h. Θ may be obtained using Equation 1:

$$\text{θ=} {\text{sin}}^{- 1} \left(\begin{matrix}h \\ ⋯ \\ a\end{matrix}\right) \times \frac{180 °}{\text{π}}$$

The renewable energy generator 1 may arbitrarily control the tilt of the renewable energy generator 1 by use of the main motor 124 and the auxiliary motor 161. The main motor 124 and the auxiliary motor 161 may be used as both a generator motor and a driving motor. If the controller 15 determines that the tilt of the renewable energy generator 1 needs to be arbitrarily controlled or that a predetermined motion needs to be generated, the controller 15 may switch the main motor 124 and the auxiliary motor 161 to the driving mode.

When the main motor 124 is driven, the gear set 125 may rotate, and the pendulum rotation shaft 123 connected to the gear set 125 also may rotate, actuating the pendulum 122. When the auxiliary motor 161 is driven, the auxiliary gear unit 162 may rotate, and the main rotation shaft 14 connected to the auxiliary gear unit 162 also may rotate, allowing the main generation unit 12 to rotate. The renewable energy generator 1 may move by slight movements of the pendulum 122 and the main generation unit 12, which, as a result, allows for arbitrary control of the tilt of the renewable energy generator 1 and for generation of a predetermined motion.

According to an exemplary embodiment of the present disclosure, a renewable energy generator according to an exemplary embodiment has an effect of producing electric power in coastal and offshore waters and distant seas by converting wave energy into electrical energy without limiting conditions for installation.

According to an exemplary embodiment of the present disclosure, a renewable energy generator according to an exemplary embodiment has an effect of increasing the power generation efficiency of the renewable energy generator by controlling motors by considering the intensity, speed, and cycle of waves.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by multiple control devices, or an integrated single control device.

In various exemplary embodiments of the present disclosure, the control device may be implemented in a form of hardware or software, or may be implemented in a combination of hardware and software.

Furthermore, the terms such as “unit”, “module”, etc. Included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of predetermined exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A renewable energy generator comprising:
a housing that is configured to float in a sea;
a main generation unit including an internal housing, a pendulum provided to be movable within the internal housing, a pendulum rotation shaft connected to the pendulum and rotatably connected to the internal housing, a main motor configured to convert the pendulum’s kinetic energy into electrical energy, and a gear set coupling the main motor and the pendulum rotation shaft and configured to transfer the kinetic energy of the pendulum to the main motor;
one or more frames fixed to the inside of the housing at predetermined intervals;
a main rotation shaft rotatably connecting the main generation unit to at least one of the one or more frames for the main generation unit to rotate with respect to the at least one of the one or more frames; and
a controller configured to control the main generation unit.

2. The renewable energy generator of claim 1, wherein the one or more frames includes an upper frame and a lower frame, and the main generation unit is positioned between the upper frame and the lower frame and rotatably coupled therebetween.

3. The renewable energy generator of claim 1, further including:
an auxiliary gear unit positioned outside the main generation unit and connected to the main rotation shaft; and
an auxiliary generation unit including an auxiliary motor coupled to the auxiliary gear unit.

4. The renewable energy generator of claim 3, wherein the controller is configured to rotate the main rotation shaft by controlling the auxiliary generation unit.

5. The renewable energy generator of claim 3, wherein the auxiliary generation unit produces electrical energy by use of movement of the renewable energy generator.

6. The renewable energy generator of claim 1, wherein the main generation unit further includes:
a rotating angle sensor that is configured to detect a rotation angle and a rotation speed of the pendulum rotation shaft; and
a gyro sensor which is configured to measure changes in intensity of waves in the sea.

7. The renewable energy generator of claim 1, further including a communication module configured to measure absolute coordinates of the renewable energy generator.

8. The renewable energy generator of claim 7, wherein the communication module is mounted on an inside top portion of the housing or at a bottom center portion of the internal housing.

9. The renewable energy generator of claim 1, wherein the housing further includes a solar panel on an external surface of the renewable energy generator and configured to absorb solar energy.

10. The renewable energy generator of claim 9, wherein the housing includes external walls having a predetermined height, and the solar panel is mounted in grooves formed between the external walls.

11. The renewable energy generator of claim 9, further including a solar generator configured to convert the solar energy absorbed by the solar panel into the electrical energy.

12. The renewable energy generator of claim 1, wherein the internal housing includes a stumbling block configured to restrict motion of the pendulum in a predetermined range.

13. The renewable energy generator of claim 12, wherein the stumbling block includes a stopper connected to a spring configured to cause the pendulum to recoil.

14. The renewable energy generator of claim 12, wherein the stumbling block includes a first stumbling block to restrict the motion of the pendulum in a first rotation direction of the pendulum and a second stumbling block to restrict the motion of the pendulum in a second rotation direction of the pendulum.

15. The renewable energy generator of claim 1, further including a battery configured to store the electrical energy.

16. The renewable energy generator of claim 15, further including a cable configured to transfer the electrical energy stored in the battery to a predetermined place.

17. The renewable energy generator of claim 1,
wherein the gear set includes a first gear set and a second gear set,
wherein the main motor includes a first main motor and a second main motor,
wherein the first gear set is coupled to a first end portion of the pendulum rotation shaft and the first main motor and the second gear set is coupled to a second end portion of the pendulum rotation shaft and the second main motor.

18. The renewable energy generator of claim 17, wherein the first gear set and the first main motor are aligned symmetric with the second gear set and the second main motor with respect to the pendulum.

19. The renewable energy generator of claim 3, wherein the main motor is a motor-generator and the auxiliary motor is a motor-generator so that the main motor and the auxiliary motor are selectively changed to a motor mode or a generator mode by the controller.
